(19) United States
(12) Patent Application Publication
(10) Pub. No.: US 2008/0024824 A1
(43) Pub. Date: Jan. 31, 2008

(54) DATA PROCESSING METHOD AND MULTIFUNCTION PRINTER

(75) Inventor: Nobuo Onuma, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/780,465

(22) Filed: Jul. 19, 2007

(30) Foreign Application Priority Data
Jul. 25, 2006 (JP) 2006-202327
Sep. 29, 2006 (JP) 2006-268311

(51) Int. Cl. G06F 15/00

(52) U.S. Cl. 358/1.18

(57) ABSTRACT

Changes in grayscale data of groups of pixels in edge portions of the original image are detected. According to the changes detected, new grayscale data is generated for the edge surrounding portions that adjoin the edge portions from outside. With this processing, a marginless printed matter which maintains continuity can be obtained without the original data being enlarged or lost. The direction of a trimmed image with respect to the printing direction is set in a way that allows as much of the original image as possible to be allocated to the images of the edge surrounding portions required to be arranged around the trimmed image for the marginless printing. With this arrangement, if errors should occur in the print position, it is possible to realize a “marginless printing” which, in areas between the trimmed area and the edge surrounding portions, gives a viewer no unnatural feel.

### BACKGROUND OF THE INVENTION

1. Field of the Invention

The present invention relates to an image data processing method for marginless printing or edge-to-edge printing of an image on a print medium and to a multifunction printer capable of executing the method.

2. Description of the Related Art

Recent years have seen a growing number of relatively inexpensive, multifunction printers on the market replacing single-function printers that only print image data. Such multifunction printers largely comprise a scanner, a printing apparatus, a memory card reader and a user interface unit, and any combination of these is used to realize desired multiple functions. Generally, the scanner and the printing apparatus are combined to realize a copy function, or the memory card reader and the printing apparatus are combined to realize a card direct printing function that prints photographs shot by a digital camera.

In the copy function and the card direct printing function, there is a growing demand for a so-called “marginless printing”, that outputs images with no blank areas left at edges of a print medium. And a large number of multifunction printers with this marginless printing function are also available on the market. That is, the copy function, when it performs the “marginless printing”, can copy an original in a way that produces no blank areas at edges of an output medium and the card direct printing function can perform the edge-to-edge printing of photographs shot by a digital camera.

The marginless copying involves enlarging an original image read in by a scanner to image data of a size slightly larger than a specified size of the print medium. The marginless photograph printing also involves resizing an image file read out from a memory card to a size slightly larger than the specified size of the print medium. These enlarging and resizing operations produce image data that is printed over the entire print medium and also in an area slightly extending beyond front and rear edges or left and right edges of the print medium (hereinafter called an edge surrounding portion). As a result, if there are some errors in the transport precision of the printing apparatus, a “marginless printing” can be realized which has no blank areas left at the edges of the print medium.

The marginless copying that involves the enlargement operation as described above, however, has a drawback that because the copying operation automatically enlarges the entire image, the commonly used equal-size copying cannot be performed. Another problem is that, when the marginless copying is done repetitively to produce a child copy and a grandchild copy, the enlargement operation is executed each time the copying is performed, causing information arranged at edge portions of the original to be gradually lost beginning with the outer ends.

The similar problem is also expected when the marginless photograph printing is performed by executing the resizing. An image in an edge surrounding area, the area that is expected to be printed outside the edges of the print medium, is in most cases not printed on the print medium. This means that, in the case of a photograph of a gathering, for example, persons standing at the left or right end of the group of people fail to be printed.

To cope with these problems, Japanese Patent Laid-Open No. 2003-274149 discloses a method for realizing the “marginless printing” without executing the enlarging or resizing operation. This document describes a method which, when performing the “marginless printing” by trimming a part of the image data, uses data outside the trimming frame as the image data in the edge surrounding portion. If there is no image data outside the trimming frame because the trimming frame matches the edges of the image or the entire image is trimmed, pixels at the edges of the image are repetitively copied to generate image data in the edge surrounding portions interpolatingly. This method obviates the need for enlarging or resizing the image data inside the trimming frame, thus eliminating the possibility of information inside the frame being lost or damaged.

The method of Japanese Patent Laid-Open No. 2003-274149, however, has a drawback. When there is no image data outside the frame, a continuity may be lost at the boundary between an image inside the trimming frame and an image in the edge surrounding portions generated by a simple copying, making a viewer feel visually incongruous. To be more specific, let us consider an image in which color and density vary relatively greatly, such as a landscape picture of red leaves. Even in marginless-printing such a landscape image, the method of Japanese Patent Laid-Open No. 2003-274149 generates data in edge surrounding portion by successively copying a part of data situated at the outermost edge of the image of an original. So, the variations in color and density in the original image fail to be reproduced, giving an incongruous visual feel.

That is, to ensure a stable “marginless printing” that gives a viewer no unnatural feel, the temporal area generated by interpolation should be kept as small as possible. Japanese Patent Laid-Open No. 2003-274149, however, does not necessarily make any provision to minimize the interpolated area.

FIG. 1 schematically illustrates the problems experienced with Japanese Patent Laid-Open No. 2003-274149. In the figure, designated 101 is an area of a print medium on which the “marginless printing” is performed. An arrow represents a direction of transport of this print medium in the printing apparatus. An area 102 indicates an image area that the printing apparatus requires in order to marginless-print on the print medium area 101. The image area 102 is front, rear, left and right margins added to the print medium area 101.

In the printing apparatus, the front end portion and the rear end portion of the print medium may not be transported with the same precision due to mechanical characteristics of the printing apparatus. For example, the transport rollers to hold and transport the print medium are provided in pairs upstream and downstream of the print position of the print head. When the front and rear end portions of the print medium are printed, the print medium is transported by one of the two pairs of transport rollers. Any transport precision difference between these roller pairs results in a print position precision difference between the front end portion and the rear end portion. Generally, the rear end portion often has a lower transport precision than the front end portion. As a result, the edge surrounding portion required in executing the “marginless printing” is greater in width at the rear end portion than at the front end portion. Further, at the left and right edge portions of the print medium an image cannot necessarily be printed at the same precision because of unwanted conditions such as a tilted feeding of the print medium. That is, the edge surrounding portions required in executing the “marginless printing” vary in width among the front, rear, left and right end portions of the print medium according to the mechanical characteristics of the printing apparatus. The figure shows a case where 2-mm-wide edge surrounding portions are provided at the front, left and right end portions and a 5-mm-wide edge surrounding portion at the rear end portion.

FIG. 2 illustrates an example in which the printing apparatus that requires the edge surrounding portions described above trims an upper left corner of the image of the original read in by a scanner. A trimming frame 111 is a frame to specify an area to be picked up from the original image 110 for printing. For simplicity, here is shown a case where the trimming frame 111 is similar to the print medium area 110. The actual trimming frame does not have to be similar to the print medium.

FIG. 3 illustrates an image area 102 required when the “marginless printing” according to the Japanese Patent Laid-Open No. 2003-274149 is performed on an image region specified by the trimming frame 111 of FIG. 2. The transport direction of the print medium is represented by the arrow, and thus the image data for the edge surrounding portions at the front and right ends can mostly be prepared from the original image. At the rear and the left ends, however, there is not enough original image data and therefore a large volume of image data for these edge surrounding portions needs to be generated by interpolation. In the figure, this area is shown hatched as an interpolated data generation area 112.

The edge surrounding portions represent image areas which have a possibility of being printed at the edges of the print medium depending on the transport errors. The wider the edge surrounding portions, the more likely they are to be printed on the print medium when the “marginless printing” is executed. If the edge surrounding portions, for which data has been generated by interpolation, are printed in too wide an area, there is an increased concern that an unnatural visual feel may be generated between the edge surrounding portions and the original image inside the trimming frame. That is, if the area for which the image data needs to be generated by interpolation corresponds to the rear edge surrounding portion 104 with the largest width, the effect of Japanese Patent Laid-Open No. 2003-274149 cannot be produced to the fullest extent.

### SUMMARY OF THE INVENTION

The present invention has been accomplished with a view to overcoming the above problem. It is therefore an object of this invention to realize a preferable “marginless printing” which, even when executed by trimming an original image, can minimize a data area temporarily generated by interpolation and therefore produces no unnatural visual feel. It is also an object of this invention to provide an image processing method capable of realizing the “marginless printing” that does not lose image continuity at the edge surrounding portions of a print medium even when data is generated by interpolation.

The first aspect of the present invention is a data processing method for a marginless printing, wherein the marginless printing prints an original image, composed of a plurality of pixels having multiple levels of grayscale data, on a print medium with no blank margins left at its edges, the data processing method comprising the steps of: detecting changes in grayscale data of groups of pixels in edge portions of the original image beginning with an inside of the edge portions toward their outside, the edge portions having a predetermined width from peripheral edges of the original image toward its inside; creating new groups of pixels having grayscale data in edge surrounding portions adjoining the edge portions from the outside according to the changes detected; and combining the original image and the edge surrounding portions to create image data for marginless printing.

The second aspect of the present invention is a multifunction printer capable of printing an original image, composed of a plurality of pixels having multiple levels of grayscale data, on a print medium with no blank margins left at its edges, the multifunction printer comprising: means for receiving a print command; means for obtaining image data according to the print command; means for detecting changes in grayscale data of groups of pixels in edge portions of the image data beginning with an inside of the edge portions toward their outside, the edge portions having a predetermined width from peripheral edges of the image data toward its inside; means for creating new groups of pixels having grayscale data in edge surrounding portions adjoining the edge portions from the outside according to the changes detected; means for combining the image data and the edge surrounding portions to create image data for marginless printing; and means for printing ink on the print medium based on the created image data.

The third aspect of the present invention is an image processing method for printing an image trimmed from a part of an original image on a print medium, with no blank margins left at its edges, the image processing method comprising the steps of: setting a direction of the trimmed image with respect to a direction of printing on the print medium so that images of edge surrounding portions arranged around the trimmed image and having a predetermined area can be obtained from as much of the original image as possible; copying the original image to create the images of the edge surrounding portions; temporarily generating images of those of the edge surrounding portions which are not created by copying the original image; combining the original image and the temporarily generated images to create images of the edge surrounding portions; and printing a combination of the trimmed image and the images of the edge surrounding portions on the print medium according to the set direction of the trimmed image.

The forth aspect of the present invention is a multifunction printer for printing an image trimmed from a part of an original image on a print medium, with no blank margins left at its edges, the multifunction printer comprising: means for setting a direction of the trimmed image with respect to a direction of printing on the print medium so that images of edge surrounding portions arranged around the trimmed image and having a predetermined area can be obtained from as much of the original image as possible; means for copying the original image to create the images of the edge surrounding portions; means for temporarily generating images of those of the edge surrounding portions which are not created by copying the original image; means for combining the original image and the temporarily generated images to create images of the edge surrounding portions; and means for printing a combination of the trimmed image and the images of the edge surrounding portions on the print medium, with no blank margins left, according to the set direction of the trimmed image.

Further features of the present invention will become apparent from the following description of exemplary embodiments (with reference to the attached drawings).

### BRIEF DESCRIPTION OF THE DRAWINGS

FIG. 1 is a schematic diagram showing an example problem experienced with a prior art;

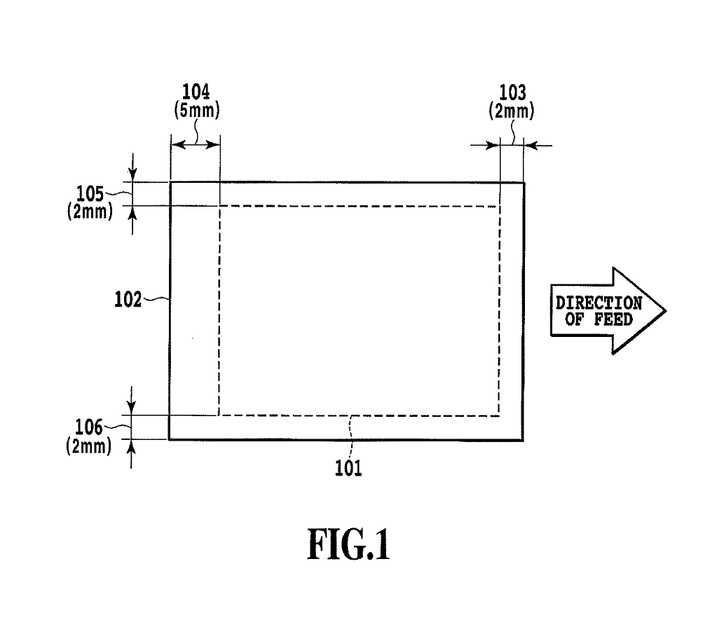

FIG. 2 illustrates an example case where an upper left corner of an original image is trimmed for marginless printing performed by a printing apparatus that requires edge surrounding areas;

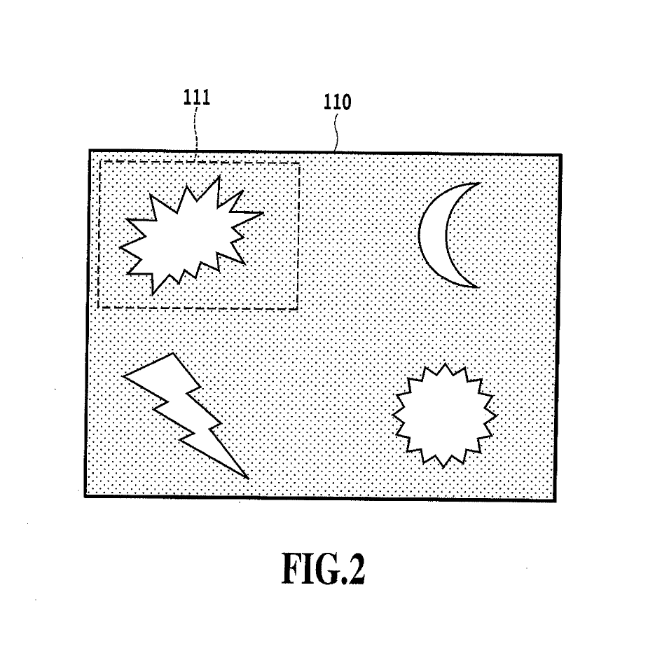

FIG. 3 illustrates an additional image area required when a part of an image cut off by a trimming frame is “marginless-printed” according to a conventional technology.

FIG. 4 is a block diagram showing a control configuration of a multifunction printer applicable to this invention;

FIG. 5 is a flow chart showing a series of operations performed by the multifunction printer to execute a marginless copying with a unity magnification factor;

FIG. 6 illustrate an example image sample used in embodiment 1;

FIG. 7 is a schematic diagram showing image data to be printed in edge surrounding areas during a marginless copying;

FIG. 8 is a schematic diagram showing variables L, S, N and a method of generating density data used to generate image data to be printed in the edge surrounding areas in the embodiment of this invention;

FIG. 9 is a schematic diagram showing how an image is generated at a corner of the edge surrounding areas;

FIG. 10 is a schematic diagram showing image data generated for a marginless photograph printing;

FIG. 11 is a flow chart showing a series of operations performed by the multifunction printer to execute a marginless photograph printing;

FIG. 12 is a flow chart showing a series of operations performed by the multifunction printer to execute a marginless copying by trimming;

FIG. 13 is a schematic diagram showing a direction of printing and edge surrounding areas when a temporarily set printing direction is changed; and

FIG. 14 is a flow chart showing a series of operations performed by the multifunction printer to execute a marginless photograph printing by trimming a part of a photograph image.

### DETAILED DESCRIPTION OF PREFERRED EMBODIMENTS

Now, preferred embodiments of the present invention will be described in detail by referring to the accompanying drawings.

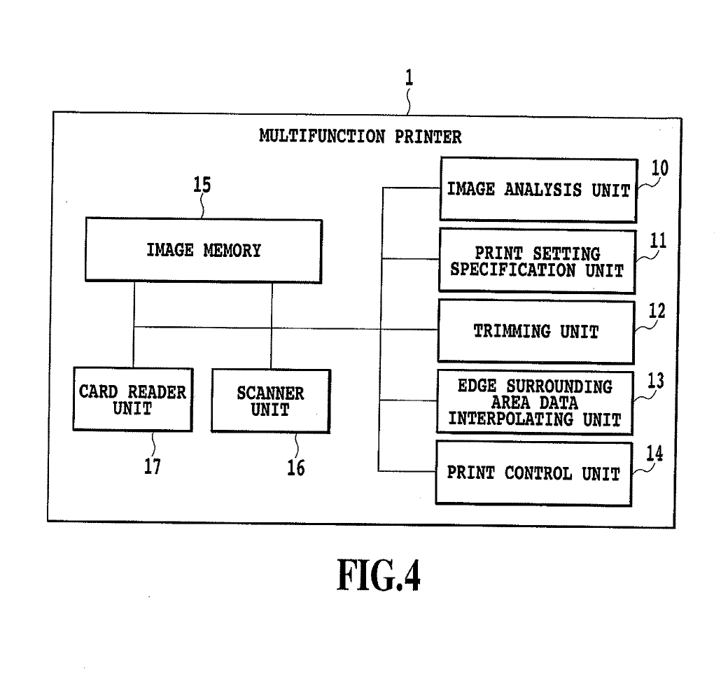

FIG. 4 is a block diagram showing a control configuration of a multifunction printer 1 applicable to this invention. A print setting specification unit 11 has a user interface for receiving function settings and a print start command from a user. An image analysis unit 10 analyzes image data stored in an image memory 15 according to a command set in the print setting specification unit 11. A trimming unit 12 trims the image data stored in the image memory 15 according to a command output from the print setting specification unit 11. A card reader unit 17 reads image data from a card memory of, for example, a digital camera, and transfers it into the image memory 15. A scanner unit 16 reads an original placed on a scanning table, converts it into image data and transfers the converted image data to the image memory 15. The image memory 15 temporarily stores image data received from the card reader unit 17 or the scanner unit 16.

The image analysis unit 10 analyzes the image data stored in the image memory 15 and converts it into image data the print control unit 14 can handle. The trimming unit 12 analyzes the image data stored in the image memory 15 according to a command output from the print setting specification unit 11. The trimming unit 12 then specifies a method of generating edge surrounding area data for an edge surrounding area data interpolating unit 13 and also specifies a direction of printing the image data, thereby converting the image data stored in the image memory 15 into image data that can be printed by the print control unit 14. Based on the image data converted by the image analysis unit 10 and the edge surrounding area data generation method specified by the trimming unit 12, the edge surrounding area data interpolating unit 13 generates image data in the edge surrounding areas in four directions.

The image data developed by the image analysis unit 10 or the trimming unit 12 and the edge surrounding area data generated by the edge surrounding area data interpolating unit 13 are sent to the print control unit 14. The print control unit 14 prints an image on a print medium according to the data received.

In the following, embodiments of outputting a variety of images with no blank margins will be explained in detail by using the multifunction printer 1 shown in FIG. 4.

### Embodiment 1

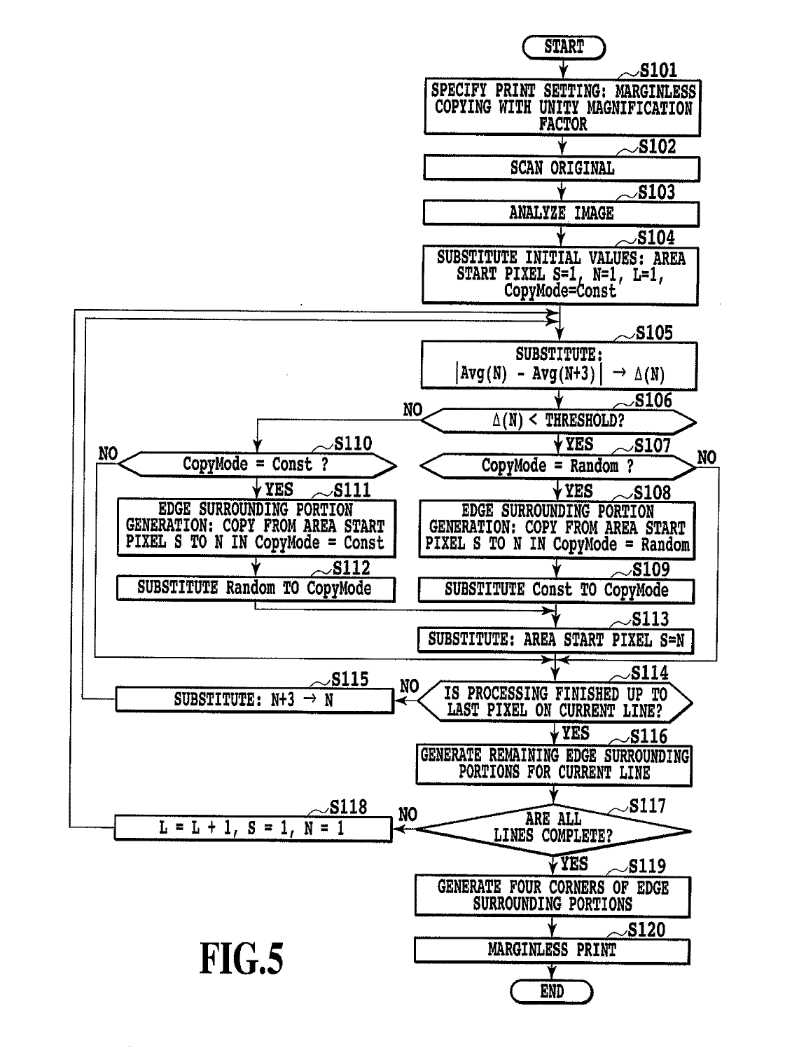

FIG. 5 is a flow chart showing a series of steps that the multifunction printer 1 of this embodiment shown in FIG. 4 executes to perform a marginless copying with a unity magnification factor.

Once the processing is started, at step S101 the print setting specification unit 11 sets a command as specified by the user through the user interface. In this embodiment, a “marginless copy mode with unity magnification factor” is set.

At the next step S102, the scanner unit 16 reads an original put on the scanning table and stores the image data scanned in the image memory 15. More specifically, the scanner unit 16 optically reads a reflection density of the entire image area of the original at a specified resolution and stores the readings as brightness data for red (R), green (G) and blue (B) in the image memory 15 for each pixel.

At step S103 the data stored in the image memory 15 is processed for each pixel by the image analysis unit 10 for conversion into image data that can be printed by the print control unit 14. The print control unit 14 of this embodiment uses six color inks—cyan (C), light cyan (LC), magenta (M), light magenta (LM), yellow (Y) and black (Bk)—to form an image using an ink jet printing method. The image analysis unit 10 therefore performs color separation on the R, G, B brightness data stored in the image memory 15 to convert the brightness data into density data for C, LC, M, LM, Y and Bk for each pixel.

In the case of other than the marginless copying, the density data thus obtained is transferred as is to the print control unit 14 for printing. However, in the marginless copying as in this embodiment, density data for the print medium edge surrounding areas needs to be generated.

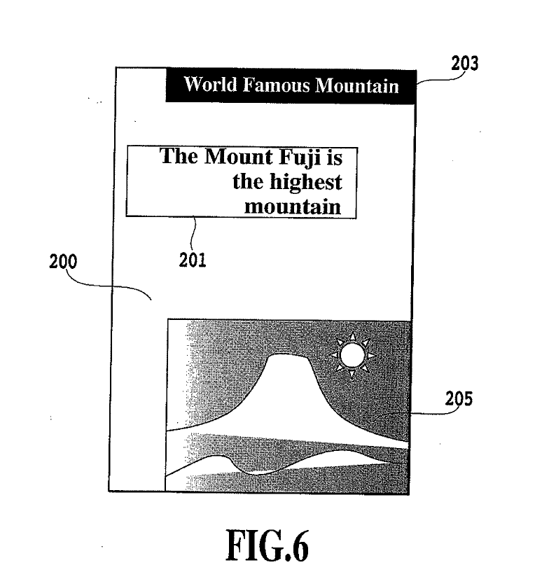

FIG. 6 shows an example of an image sample (original 200) used in this embodiment. The original has a picture portion 205 at the lower right, a text portion-1 203 at the upper right with white characters on a black ground, a text portion-2 201 at the central part with black characters on a white ground. An example process of marginless-copying such an original image will be described as follows.

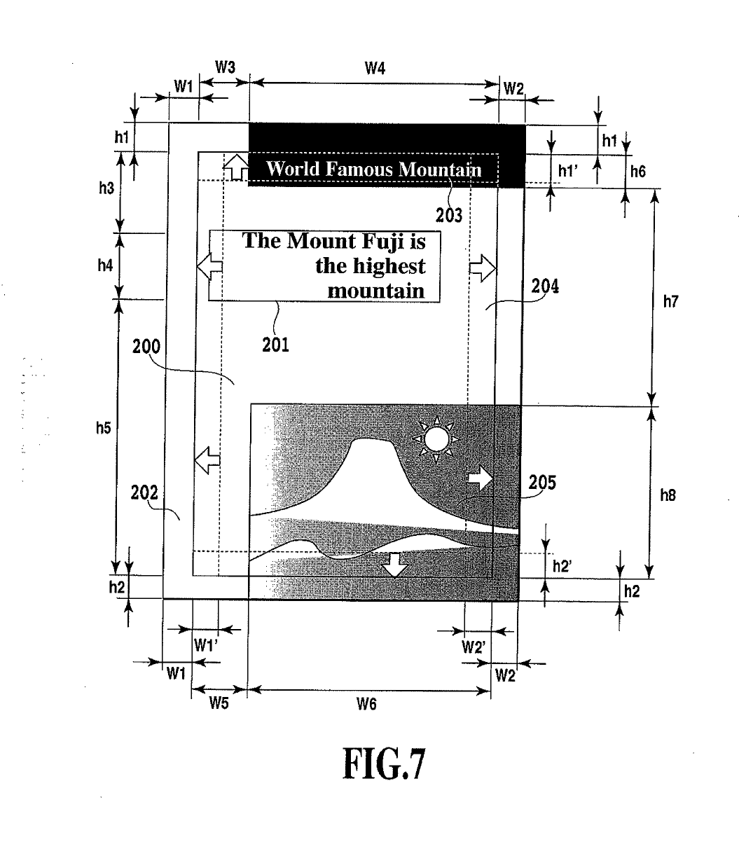

FIG. 7 is a schematic diagram showing how image data at the edge surrounding portion 202 is generated for marginless copying of the original 200. Portions included in areas with horizontal widths w1 and w2 and areas with vertical widths h1 and h2 constitute an edge surrounding portion 202 for which image data needs to be generated. In the figure, the picture portion 205 and the text portion-1 203 arranged at the ends of the original 200 have their data generated so that they extend into the edge surrounding portions but that their content is not magnified. The feature of this embodiment is that the data at the edge surrounding portions is newly added without impairing the gradation and uniformity of the original. More specifically, data at the edge surrounding portions included in w1 and w2 and in h1 and h2 is generated by using data of those areas directly inside the edges of the original 200 which have the same widths as the adjoining edge surrounding portions, namely data of areas included in w1′ and w2′ and in h1′ and h2′ (hereinafter referred to as edge portions).

As a preliminary step, variables L, S, N and CopyMode are set to their initial values at step S104.

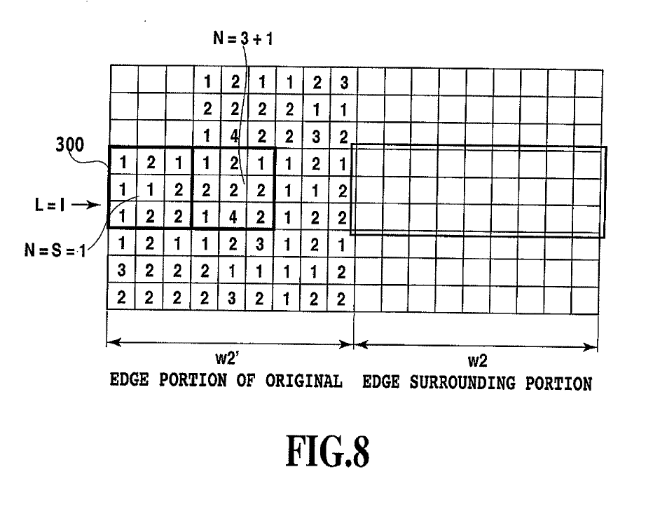

FIG. 8 is a schematic diagram showing the variables L, S, N used to generate image data in the edge surrounding portions and the method of generating density data in this embodiment. Here, let us take a part of the right side area of the original 200 for example. In this diagram, small squares represent individual pixels and each of those pixels included in w2′ is given a density value of one color that is obtained through conversion by the image analysis unit 10. In this embodiment, a window 300 of a 3×3-pixel area is shifted from the left end of w2′ toward right along the line 1 to detect a change in the density value between adjoining window areas. According to the amount of change, density data in an area enclosed by a medium thick line in the edge surrounding portion adjoining the scanned area is generated one after another.

The shifting of the window 300 is performed from the inside toward the outside of the original's edge portions, as indicated by blank arrows in FIG. 7, to generate density data in the edge surrounding portions that adjoin the edge portions from outside. The window shifting and the density data generation are performed over the entire periphery of the original. In this embodiment a variable L is provided in order to manage the shift line of the window 300 for one circle of the original. S is a variable representing a start position of scan in line L, and N is a variable representing a pixel of interest to be watched as the processing starts from S and proceeds along line L. Referring again to FIG. 5, at the stage of step S104, these variables L, S, N are all set to 1.

At step S104, CopyMode is a variable that determines whether the method of generating data for the pixels included in the edge surrounding portions is made random (Random) or constant (Const). It is set to Const as an initial value.

In the subsequent step S105, an average density Avg(N) in the window 300 at the current pixel position N is determined. Then, a density difference between the average density Avg(N) and an average density Avg(N+3) of an area shifted in the L direction by one window, ΔN=|Avg(N)−Avg(N+3), is determined. In the case of FIG. 8, Avg(N) is an average density for nine pixels included, i.e., about 1.4. Avg(N+3) is an average density for the 3×3-pixel area adjoining on the right side, i.e., about 1.9. As a result, ΔN=|Avg(N)−Avg(N+3) is about 0.5.

Step S106 compares ΔN determined by step S105 with a preset threshold Th. If ΔN<Th, it is decided that the density change between the area of pixel of interest and the adjoining area is small. The processing moves to step S107. If ΔN>=Th, it is decided that the density change between the areas is large. Then the processing moves to step S110.

At step S107, a check is made as to whether CopyMode is Random or not. If CopyMode is not Random, i.e., CopyMode is Const, it is decided that data at the edge surrounding portions can be generated in the constant CopyMode in at least an area from S to N in the current line L. The processing moves to step S114.

If, on the other hand, step S107 finds that CopyMode=Random, the processing proceeds to step S108, which causes the edge surrounding area data interpolating unit 13 to generate image data at the edge surrounding portions. Executing step S108 means that step S106 has decided that the grayscale change between the adjoining pixel areas is small and also that step S107 has decided that CopyMode is set in Random. That is, since the grayscale variation is large in the area from the data generation start pixel S to the current pixel of interest N, the data generation should appropriately be performed in the Random mode in this area.

For example, in parts of the picture portion at the lower right of FIG. 7, w2′×h8 and w6×h2′, the density is not uniform and thus the Random mode is applied. In the Random mode of this embodiment, image data at the edge surrounding portions adjoining the edge portions of the picture from outside can be generated by a mirroring copy of the image data at the edge portion. That is, for w2×h8 data, the area w2′×h8 may be mirror-copied laterally symmetrically with the right edge of the original as a symmetric line. For w6×h2 data, the area w6×h2′ may be mirror-copied vertically symmetrically with the lower edge of the original as a symmetric line. Alternatively, rather than using the mirroring copy, the density values in the edge portions w2′×h8 and w6×h2′ may be used to generate data for the edge surrounding portions w2×h8 and w6×h2 by extrapolation. When the generation of data for the edge surrounding portions corresponding to the edge portions from S to N is completed, the processing moves to step S109 where it sets CopyMode to Const.

Step S110 checks whether CopyMode is Const or not. If it is not Const, i.e., CopyMode is Random, the step decides that at least in the area from S to N, the data for the edge surrounding portions should be generated in the Random CopyMode, before moving to step S114.

If step S110 finds that CopyMode=Const, it moves to step S111. Executing step S111 means that step S106 has decided that the grayscale change between the adjoining pixel areas is large and also that step S110 has decided that CopyMode is set in Const. That is, since the grayscale variation is small in the area from the data generation start pixel S to the current pixel of interest N, the data generation should appropriately be performed in the Const mode in this area.

In the original shown in FIG. 7, the above-described decision is made for the entire edge portions except for the parts of the lower right picture portion w2′×h8 and w6×h2′. The image data for the edge surrounding portions that adjoin the edge portions from outside may be generated by copying the image data of the edge portions or by copying those edge portion image data whose density variations do not exceed the threshold Th. In that case, the value of Avg(N) of the outermost portion determined by step S105 may be copied as is. When the data generation for the edge surrounding portions corresponding to the edge portions from S to N is completed, the processing moves to step S112 where it sets CopyMode to Random.

After the CopyMode setting is finished at step S109 or S112, the processing moves to step S113 where it sets the area start pixel S to the current pixel N of interest, before proceeding to step S114.

Step S114 makes a decision as to whether the scan has been performed until N becomes the final pixel of the current line L. If it is found that pixels to be scanned still remain in the current line (the scan has not reached the end of the original), the processing moves to step S115 where it increments the pixel of interest N by three pixels, which is equal to the window size, before returning to step S105. On the other hand if step S114 decides that the window scan has been performed up to the last pixel of the current line, the processing moves to step S116.

Step S116 generates, according to the current CopyMode, density data for the areas where the density data has yet to be created on the current line. With this step, the whole process to be performed on the line of interest L is completed.

In the subsequent step S117, a check is made as to whether the window scan and the density data generation have been finished for all lines. If it is decided that there are lines for which the scan and the density data generation have not been completed, step S118 increments the line L and returns the variables S and N to the initial value 1. Then, the processing returns to step S105 to start the scan on the next line L.

If step S117 has found that the window scan and the density data generation have been performed for all lines in the original, the processing moves to step S119 where it generates density data for four corners of the edge surrounding portions.

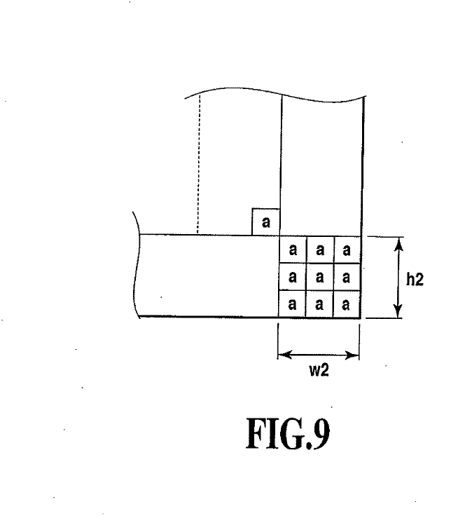

FIG. 9 schematically shows how image is generated in a w2×h2 area, one of the corners of the edge surrounding portions. Data for such a corner area (w2×h2 area) is generated by copying as is the data (a) in the 3×3-pixel area situated at one corner of the original's image 200. For other three corners of the edge surrounding portions, too, the density data is generated in the similar way.

When the density data for the four corners have been created by step S119, the processing moves to step S120. At step S120, the print control unit 14 combines the density data of the original's size generated by the image analysis unit 10 and the density data of the edge surrounding portions generated by the edge surrounding area data interpolating unit 13 to create one piece of marginless copy data. Then, using this density data of the copy data, the marginless copying is executed. Now, this processing is complete.

Referring again to FIG. 7, a material printed according to the processing described above has its edge portions adjoining the picture portion 205 printed in such a manner that a smooth gradation is maintained. In the text portion-1 203 where black solid-printed areas occur continuously, the edge portions are printed so as to extend the solid-printed areas. That is, in this embodiment, even if the marginless copying is done based on an original whose characteristic changes from one location to another, an image can be output which maintains continuity with no data magnification or loss and which gives no unnatural feel.

### Embodiment 2

In this embodiment, the processing for a marginless photograph printing using the multifunction printer of FIG. 4 will be explained.

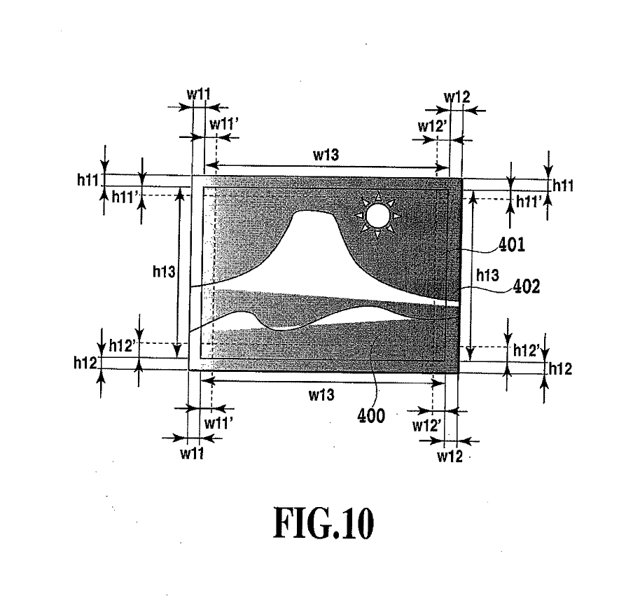

FIG. 10 shows image data to be generated for a marginless photograph printing of an original image 400. In the figure, a rectangle having h13 and w13 as its sides represents the original image 400. Areas w11, w12, h11 and h12 surrounding the rectangle represent edge surrounding portions 402 to be created. In this embodiment, data in the edge surrounding portions included in w11, w12, h11 and h12 is created by using the data in those areas in the original image 400 that adjoin, and have the same widths of, the edge surrounding portions, i.e., by using the data in the edge portions 401 included in w11′, w12′, h11′ and h12′.

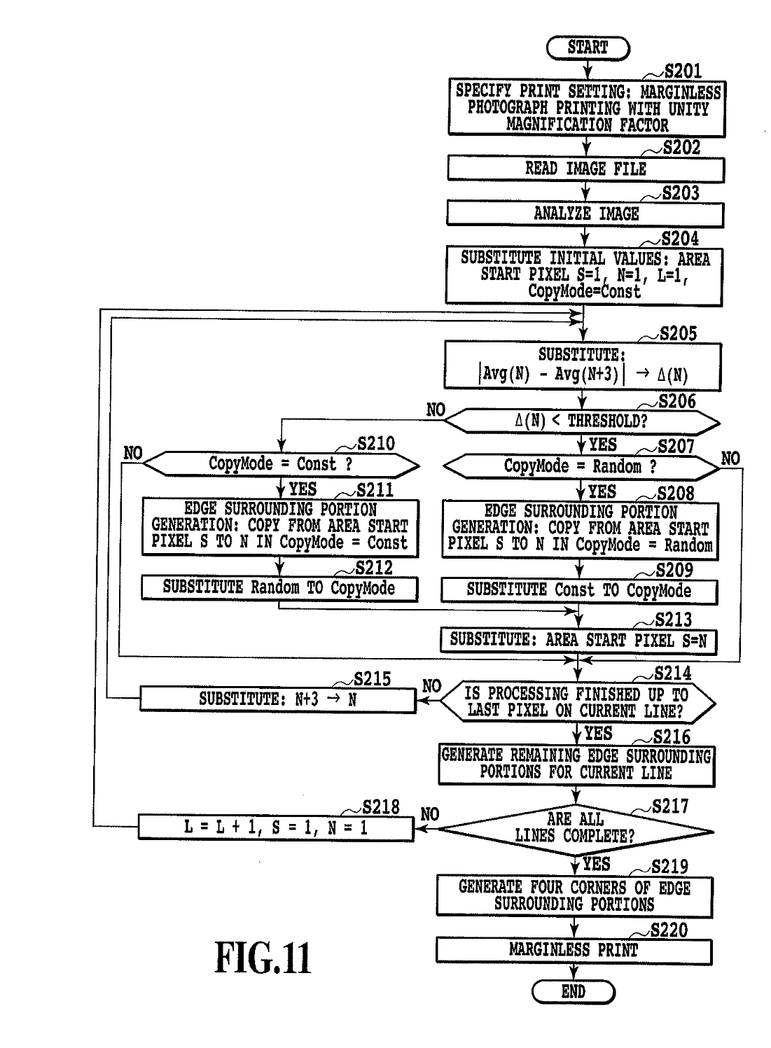

FIG. 11 is a flow chart showing a series of steps that the multifunction printer of this embodiment shown in FIG. 4 performs in executing a marginless photograph printing.

When the processing starts, at step S201 the print setting specification unit 11 sets a command specified from the user through the user interface. Here, a “marginless photograph print mode” is set.

In the next step S202, the card reader unit 17 reads image data from a memory card and stores it in the image memory 15.

The processing in and after step S203 is the same as that for the marginless copying with a unity magnification factor that was explained in embodiment 1. So, detailed explanations for each step are omitted.

The flow charts described above for the two embodiments (FIG. 5 and FIG. 11) have explained the detection of density data in the edge portions and the generation of density data in the edge surrounding portions for one color of ink. These data processing is of course performed for each of the color inks used.

In the above embodiments, the brightness data stored in the image memory 15 has been described to be color-separated by the image analysis unit 10 into the density data in order to generate image data in the edge surrounding portions. This invention, however, is not limited to this process. For example, the image data in the edge surrounding portions may be generated by first determining the amount of change in each RGB brightness data of the edge portions stored in the image memory and by comparing the change with a predetermined threshold. This also produces the intended effect of this invention and is included in the scope of this invention.

Where the image data in the edge surrounding portions is created by using the amount of change in the brightness data, rather than the density data, there is no need to newly generate the image data in the edge surrounding portions by using the density data, assuring an efficient generation of print data. For example, when one wishes to output image data enlarged from the image read by a scanner, the enlargement processing is done using the brightness data. So, the image processing unit needs only to be configured so that the enlargement processing is done using the brightness data and that the data in the edge surrounding portions is generated. This obviates the need to configure the image processing unit in a way that generates the image data in the edge surrounding portions using the density data.

Although the density data in the edge portions has been described to be detected by using the window 300 made up of 3×3 pixels, the window applicable to the above embodiment is not limited to this size. Changes in density or brightness may be detected by averaging the density or brightness in a wider area or by shifting one pixel at a time. It should be noted, however, that the smaller the window size gets, the greater the density difference or brightness difference between the adjoining areas tends to become. It is therefore desired that a proper relation be maintained between the window size and the threshold Th.

### Embodiment 3

In this embodiment we will explain a marginless copy mode in which a trimming area is specified in an original image.

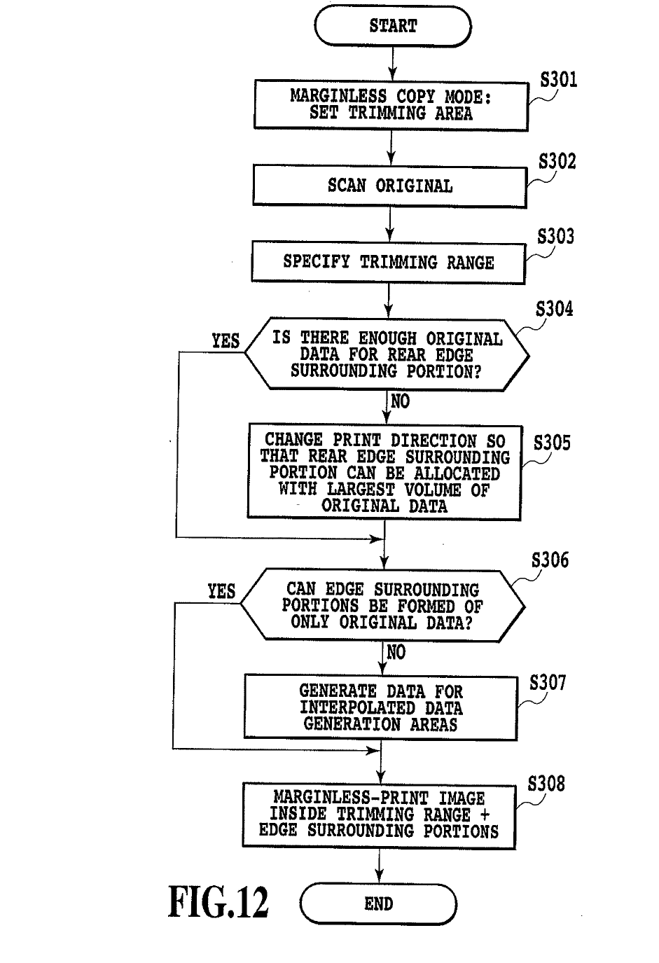

FIG. 12 is a flow chart showing a series of steps that the multifunction printer of this embodiment shown in FIG. 4 executes in performing a marginless copying with a unity magnification factor.

When the processing is started, the print setting specification unit 11 at step S301 outputs a command corresponding to the setting specified by the user through the user interface. In this embodiment, “marginless copy mode with a unity magnification factor” and a trimming area are set.

In the next step S302, the scanner unit 16 reads the original put on the scanning table and stores the image data taken in by the scanner into the image memory 15.

At step S303, the trimming unit 12 cuts an area from the original image stored in the image memory 15 based on the trimming range specified by the print setting specification unit 11 and temporarily determines the printing direction and the upper, lower, left and right edge surrounding portions.

Step S304 checks if in the printing direction temporarily determined by step S303, there is enough original data to be used for the rear edge surrounding portion in the transport direction of the print medium. If it is decided that there is enough original data for the rear edge surrounding portion, the printing direction and the upper, lower, left and right edge surrounding areas that were temporarily set by step S303 are set as final. Then the processing moves to step S306. If it is found that there is not enough original data for the rear edge surrounding portion in the transport direction, the processing moves to step S305 where it changes or converts the printing direction and the upper, lower, left and right edge surrounding areas so that there is enough original data for the rear edge surrounding portion. In a case where there is not enough original data for any of the four edge surrounding portions, as when the trimming area extends over the entire original image, the printing direction is changed or converted in a way that will provide the greatest volume of original data for the rear edge surrounding portion. That is, the printing direction is changed so that the edge surrounding portion with the largest volume of original data lies at the rear end in the transport direction. Then, based on the changed printing direction, the edge surrounding areas are set.

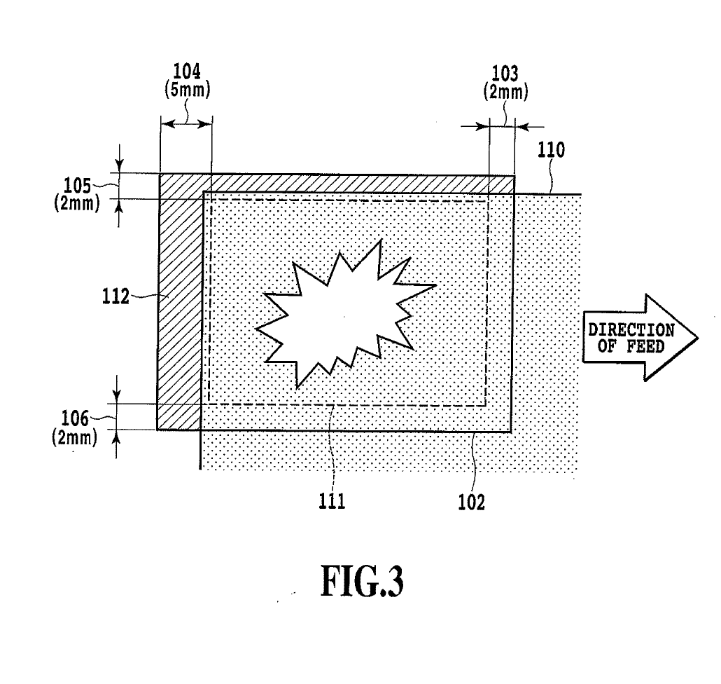

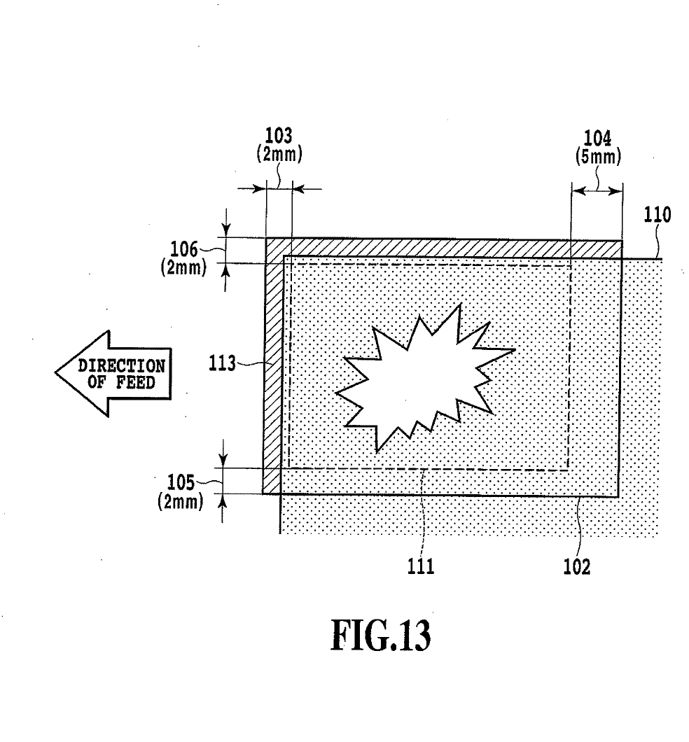

FIG. 13 shows how a printing direction and edge surrounding portions are converted or changed by step S305 when the printing direction temporarily set by step S303 is as shown in FIG. 3. If the printing direction temporarily set by step S303 is as shown in FIG. 3, step S304 decides that there is not enough original data for the rear edge surrounding portion 104 and then reverses the printing direction as shown in FIG. 13. That is, the printing direction is changed so that, in the trimmed image, the side closer to the rear end portion of the original image lies at the front in the transport direction. With this arrangement, most of the area in the rear edge surrounding portion 104 can be obtained from the original image 110, significantly reducing the interpolation data generation area 113 compared with that of FIG. 3.

Let us return to the flow chart of FIG. 12. Step S306 checks if the image data in the edge surrounding areas that are set as final can be formed from only the original data. If it is decided that the image data can be formed of only the original data, the processing moves to step S308. If it is decided that the image data cannot be formed of only the original data, as in the case of FIG. 13, the processing moves to step S307 where it generates data for areas where there is not enough original data, i.e., data for the reduced interpolation data generation area 113. There are various methods for generating interpolated data, such as mirror copying from inside the original image, continuous copying of pixel data situated at the outermost end of the original image, and performing operations similar to the above embodiments.

When the data for all the edge surrounding portions in four directions have been generated with the above steps, the processing moves to step S308 where the print control unit 14 combines the trimmed original image data and the generated data for the edge surrounding portions into one piece of marginless copy data. Then, according to the copy data and the printing direction that is set as final, the marginless copying is executed. Now, this processing is completed.

We have explained the process of “marginless copying with a unity magnification factor”. The similar process can also be executed to marginless-print a photograph shot by a digital camera.

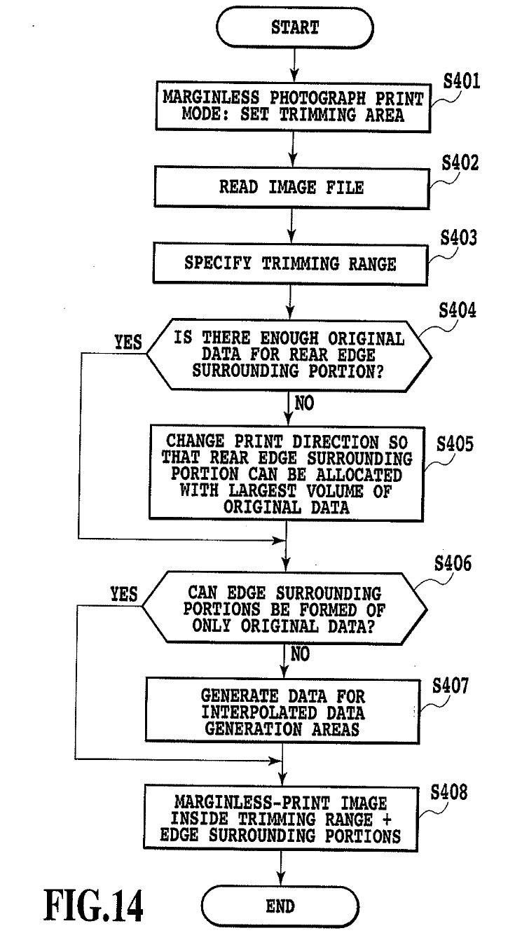

FIG. 14 is a flow chart showing a series of steps that the multifunction printer of this embodiment shown in FIG. 4 executes to perform a marginless photograph printing by trimming a part of the photograph.

When the processing is started, the print setting specification unit 11 at step S401 outputs a command corresponding to the setting specified by the user through the user interface. In this example, a “marginless photograph print mode with a unity magnification factor” and a trimming area are set.

At next step S402 the card reader unit 17 reads image data from a memory card and stores it in the image memory 15.

The processing in and after step S403 is the same as that for the marginless copying with a unity magnification factor that was explained with reference to FIG. 12. So, detailed explanations for each step are omitted.

As explained above, if, when executing the “marginless printing” in this embodiment, the edge surrounding areas at four ends of a print medium differ in size, the areas for which image data is generated by interpolation can be minimized. So, if errors should occur in the print positions when printing the end portions of the print medium, the “marginless printing” can be realized without producing unnatural, noticeable difference between the trimming area and the edge surrounding areas.

The embodiment 3 has taken up an example case where the rear edge surrounding area is larger than the front, left and right edge surrounding areas and has been described to allocate more original data to the image data of the rear edge surrounding portion. It should be noted, however, that the present invention is not limited to this case. The sizes of the edge surrounding portions required in four directions of a print medium differ from one printing apparatus to another, and the rear end portion does not always require a greater edge surrounding area than other end portions. Whatever the sizes of the edge surrounding portions in four directions and their ratio, as long as a step is included which adjusts the printing direction so as to be able to copy as much of the original data to the image data in any edge surrounding portion as possible, the process is within the scope of this invention.

The embodiment 3 has been described in a case where the trimmed original image and a print medium are similar in shape. Although this case can be said to most efficiently take advantage of the effect of this invention, the invention is not limited to such a case. In a case where the trimmed original image and the print medium are not similar in shape, the original image may be enlarged or reduced in a vertical or horizontal direction so that the trimmed image is inscribed in or circumscribed on an area of the print medium. If the trimmed image is inscribed, there may occur an area even in the print medium in which there is not enough original image data. In such a case, the required data may be created by the interpolation method described earlier. If the trimmed image is circumscribed, there may occur a case where a part of the original image gets out of the print medium. In this case, the areas outside the print medium may be used as the edge surrounding portions outside the trimming frame.

Furthermore, although the above embodiments have used the multifunction printer of FIG. 4, this invention is not limited to this configuration. For example, the means for receiving images to be stored in the image memory 15 of the multifunction printer may use a variety of devices as well as the scanner unit 16 and the card reader unit 17. The configuration may also use only one of the scanner unit 16 and the card reader unit 17. Whatever means for receiving the original image, as long as the printer used can print the image on a print medium with no blank margins, the configuration of this invention can be adopted to realize the effect of this invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Laid-Open Nos. 2006-202327, filed Jul. 25, 2006, and 2006-268311, Filed Sep. 29, 2006, which are hereby incorporated by reference herein in their entirety.

What is claimed is:

1. A data processing method for a marginless printing, wherein the marginless printing prints an original image, composed of a plurality of pixels having multiple levels of grayscale data, on a print medium with no blank margins left at its edges, the data processing method comprising the steps of:
detecting changes in grayscale data of groups of pixels in edge portions of the original image beginning with an inside of the edge portions toward their outside, the edge portions having a predetermined width from peripheral edges of the original image toward its inside;
creating new groups of pixels having grayscale data in edge surrounding portions adjoining the edge portions from the outside according to the changes detected; and
combining the original image and the edge surrounding portions to create image data for marginless printing.

2. A data processing method according to claim 1, further including the steps of:
obtaining the original image; and
printing ink on the print medium based on the image data for marginless printing.

3. A data processing method according to claim 1, wherein the edge surrounding portions have a width equal to the predetermined width.

4. A data processing method according to claim 1, wherein, if the changes detected are greater than a predetermined threshold, the pixel group creating step copies the grayscale data of the pixels included in the edge portions and creates new groups of pixels having grayscale data;
wherein, if the changes detected are smaller than the predetermined threshold, the pixel group creating step creates new groups of pixels having grayscale data whose change is not exceeding the threshold.

5. A data processing method according to claim 1, wherein the change detection step detects the changes based on an average of grayscale data of a plurality of pixels adjoining a pixel of interest.

6. A data processing method according to claim 1, wherein the grayscale data is brightness data of red, green and blue.

7. A data processing method according to claim 1, wherein the grayscale data is density data of at least cyan, magenta and yellow.

8. A multifunction printer capable of printing an original image, composed of a plurality of pixels having multiple levels of grayscale data, on a print medium with no blank margins left at its edges, the multifunction printer comprising:
means for receiving a print command;
means for obtaining image data according to the print command;
means for detecting changes in grayscale data of groups of pixels in edge portions of the image data beginning with an inside of the edge portions toward their outside, the edge portions having a predetermined width from peripheral edges of the image data toward its inside;
means for creating new groups of pixels having grayscale data in edge surrounding portions adjoining the edge portions from the outside according to the changes detected;
means for combining the image data and the edge surrounding portions to create image data for marginless printing; and
means for printing ink on the print medium based on the created image data.

9. An image processing method for printing an image trimmed from a part of an original image on a print medium, with no blank margins left at its edges, the image processing method comprising the steps of:
setting a direction of the trimmed image with respect to a direction of printing on the print medium so that images of edge surrounding portions arranged around the trimmed image and having a predetermined area can be obtained from as much of the original image as possible;
copying the original image to create the images of the edge surrounding portions;
temporarily generating images of those of the edge surrounding portions which are not created by copying the original image;
combining the original image and the temporarily generated images to create images of the edge surrounding portions; and
printing a combination of the trimmed image and the images of the edge surrounding portions on the print medium according to the set direction of the trimmed image.

10. An image processing method according to claim 9, wherein the edge surrounding portions at the front, rear, left and right ends of the print medium with respect to the printing direction are not equal in size.

11. An image processing method according to claim 9, wherein the edge surrounding portions are predetermined according to errors of a printing apparatus used in the printing step.

12. An image processing method according to claim 9, wherein the edge surrounding portion situated at the rear end of the print medium with respect to the printing direction is larger in area than the edge surrounding portion situated at the front end;
wherein the setting step sets the direction of the trimmed image with respect to the printing direction of the print medium so that the image of the edge surrounding portion situated at the rear end can be allocated with a greater volume of data from the original image.

13. An image processing method according to claim 9, further including the step of:
obtaining the original image from a scanner that optically reads an original.

14. An image processing method according to claim 9, further including the step of:
obtaining the original image by reading an image from a memory card through a card reader.

15. A multifunction printer for printing an image trimmed from a part of an original image on a print medium, with no blank margins left at its edges, the multifunction printer comprising:
means for setting a direction of the trimmed image with respect to a direction of printing on the print medium so that images of edge surrounding portions arranged around the trimmed image and having a predetermined area can be obtained from as much of the original image as possible;
means for copying the original image to create the images of the edge surrounding portions;
means for temporarily generating images of those of the edge surrounding portions which are not created by copying the original image;
means for combining the original image and the temporarily generated images to create images of the edge surrounding portions; and
means for printing a combination of the trimmed image and the images of the edge surrounding portions on the print medium, with no blank margins left, according to the set direction of the trimmed image.
